(19) United States
(12) Patent Application Publication
(10) Pub. No.: US 2011/0174887 A1
(43) Pub. Date: Jul. 21, 2011

(54) Blood type color codes

(76) Inventor: Sarella Ann Johnson, Red Ford, MI (US)

(21) Appl. No.: 12/930,935

(22) Filed: Jan. 20, 2011

Related U.S. Application Data
(60) Provisional application No. 61/336,462, filed on Jan. 21, 2010.

(51) Int. Cl. G06K 19/06

(52) U.S. Cl. 235/494

(57) ABSTRACT

My invention “Blood Type Color Coding” is to identify the different blood types with a specific color or color combination. At the present time blood types are identified by symbols, bar codes or other apparatus only in one color. Fatalities due to wrong blood type transfusion have increased yearly. Blood type Color Coding will allow a more direct way of identifying blood types enhancing the check and balancing regulated assessment and decreasing the possibility of error (a patent receiving a wrong blood type transfusion which can result in death).

I claim the benefit of the filing date of provisional application No. 61/336,462, filled on Jan. 21, 2010 and titled “Blood Type Color Codes”.

### BACKGROUND OF INVENTION

The identification of a person blood type is identified by symbols (AB−, AB+, A−, A+, B−, B+, O−, O+) or recognized by using Bar codes. No specific color identifies a specific blood type (Everything is in black and white).

The problem with every apparatus that identify blood types with each specific blood type having the same color is the possibility of error, giving a patient the wrong blood type. Blood bags with whole blood, or a blood component, identify a person blood type via universal symbols and barcodes but the color is the same for every blood bag identification method or specification, regardless of the different blood types.

Years ago medical gas tanks were all the same color regardless of the different medical gases. Due to the error of medical personal giving patients the wrong medical gas and fatalities medical gas tanks are now identified by color codes whereas each medical gas tank have a specific color which identify the type of gas within the medical gas tank.

The apparatuses used for identifying blood types (symbols, barcodes, labels, bracelets) the identification specification method gives every blood type the same identical color, enhancing the possibility of a patient receiving the wrong blood type by error.

My invention of “Blood Type Color Codes” would make it easy to identify specific blood types decreasing the possibility of error and fatalities due to wrong blood transfusions.

With “Blood Type Color Codes” each symbol, bar code and apparatuses used to identify a blood type would do so by identifying each blood type with a specific color of its own. Each “Blood Type” would be given a specific color or combination of colors. This will create a user friendly way to identify a specific blood type decreasing the possibilities of a patient receiving the wrong blood type. My invention “Blood Type Color Codes” would enhance a user friendly educational approach and preventive measures enhancing the safety of blood transfusions, and the identification of a patent blood type.

“Blood Type Color Coding” makes it easy even for a child to identify and know his or her blood type. This would be a quick way for medical personal to specify and identify visually assessment follow by regulated assessment of blood types. People can die from receiving the wrong blood type.

An article on the Safety of Transfusions has revealed that in 2004 there were 439 reports of errors, including patients receiving the wrong type of blood or blood intended for another person (Consumer Affairs Branch—CBER/FDA). The Sunday Herald, Dec. 11, 2005 by Judith Duffy Health Correspondent writes “The number of patients given the wrong blood in . . . hospital transfusions rose by more a quarter last year . . . ” The number of wrong blood transfusion fatalities has increased throughout the years. Blood Type Color Coding will help with saving lives by implementing Blood Type Color Coding to specify and Identify blood types.

### BRIEF SUMMARY OF THE INVENTION

“Blood Type Color Coding” will identify each blood type with a specific color or color combination regardless of the apparatus used for this specification. Blood Type Color Coding will enhance the precise identification of a person blood type, decreasing the possibility of a patient receiving the wrong blood via transfusions, decreasing the possibilities of error and fatalities.

### BRIEF DESCRIPTION OF THE SEVERAL VIEWS OF THE DRAWING

Please see drawings (FIG. 1A and FIG. 1B)

FIG. 1A depicts each blood type and shows the colors/s or color combinations of its symbols/s. In this figure the symbol − and + are used with the specific blood types.

FIG. 1B depicts each blood type and shows the colors/s or color combinations of its symbols/s. In this figure the symbol neg and pos are used with the specific blood types.

### DETAILED DESCRIPTION OF THE INVENTION

My invention “Blood Type Color Codes” simply uses specific colors or color combinations to identify a blood type each blood type having a different color or color combination. The Blood type Color Code is used for specification and identification of the variety of blood types. The Blood Type Color Coding would be implemented on whatever the apparatus is used to identify a blood type.

In the past regardless of what the difference of the blood type identification and specification of a blood type only used one color (black). If the identification of a blood type is on a blood bag (a bag filled with whole blood or blood components) the color is always the same regardless of the different blood types. In the hospital on a patient bracelet the identification for every patient regardless of their blood type is always the same. The Bar code or symbol used to identify the patient and his or her specific blood type is always the same color (black).

In the processing and storing of blood according to blood types the identification and specification of the blood types are the same color regardless of the many different blood types. In labeling and identifying patents for blood transfusions the identification of the blood types by symbol, bar codes and all other apparatuses the colors regardless of the many different blood types are the same.

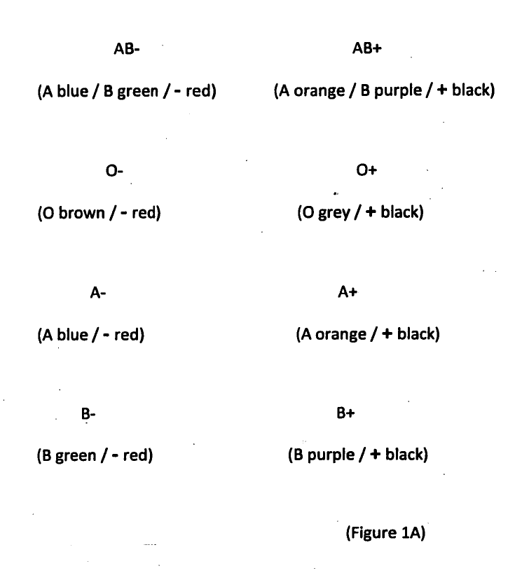

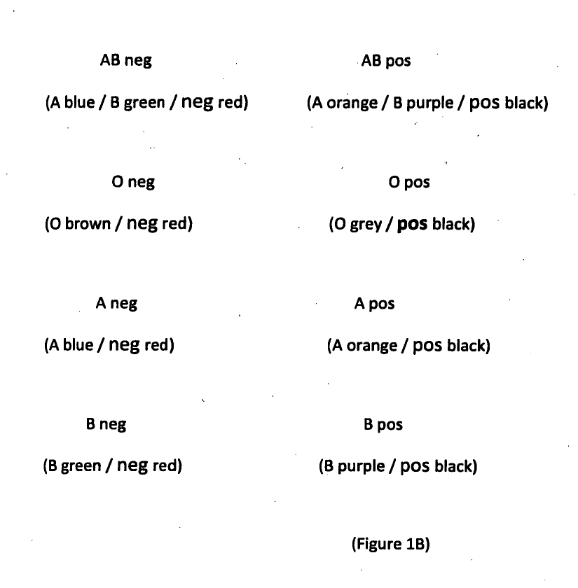

My invention of “Blood Type Color Codes” allow the identification of a specific blood type to be user friendly partnering the specific blood type with a specific color or combination of colors. In FIG. 1A all the specific blood types (AB−, AB+, B+, B−, A−, A+, O−, O+) are identified each blood type with a specific color or combination of colors. In FIG. 1B the entire specific blood types (AB pos, AB neg, B pos, B neg, A neg, A pos, O neg, O pos) the − and + signs are replaced with the spelling of neg and pos; these are just alternatives you'll seen in the medical society when identifying blood types. The blood types are partnered up with a color or color combination specifying each blood type, establishing it own identity. My “Blood Type Color Coding” would allow transfusion blood bags used to transfuse blood to a patient to have a visual color of identification which will help with decreasing the number of patients receive the wrong blood type via transfusion. Patients with bracelets identifying there blood type by using my invention of “Blood Type Collar Coding medical personal can visual observe and identity the specification of the Blood Color Code to identify blood type (will be a part of regulated safety standards for identifying blood types). Color coding is not foreign to the medical society, at the present time ‘color Coding is used for identifying medical gases (every specific medical gas tank has its own specific color that identifies what type of medical gas is within a tank). By using this color coding practice on medical gas tanks the decrease of error with medical gases (fatalities) is down tremendously.

Blood Type Color Coding will enhance the way blood types are identified by establishing by each blood type having it's own unique color a more precise check and balance that would enhance the safety of sick patients and promote user friendly understanding and safety precautions with identification and specification with all apparatus that is used to identify a person blood type.

I claim the subject matter which I regard as “Blood Type Color Coding” invention:

1. A color coding for identifying blood types in a container

2. The subject matter of claim 1 further including claim 2, blood type storage bins.

3. The subject matter of claim 1 further including claim 3 blood type storage boxes.

4. The subject matter of claim number 1 further including claim 4 blood type bags

5. The subject matter of claim number 1 further including claim 5 blood type valves

6. The subject matter of claim number 1 further including claim 6 blood type vehicles

7. The subject matter of claim number 1 further including claim 7 blood type storage shelves

8. A color coding for identify blood type for patient bracelet

9. The subject matter of claim 8 further including claim 9 blood type wrist bands

10. A color coding system for identifying blood types for using any apparatus that would convey the message

11. The subject matter of claim 10 further including claim 11 bar coding

12. The subject matter of claim 10 further including claim 12 necklaces

13. The subject matter of claim 10 further including claim 13 computer programs

14. The subject matter of claim 10 further including claim 14 clothing

15. The subject matter of claim 10 further including claim 15 rings

16. The subject matter of claim 10 further including claim 16 blood type hats

17. The subject matter of claim 10 further including claim 17 educational material
